(19) United States
(12) Patent Application Publication
(10) Pub. No.: US 2002/0100139 A1
(43) Pub. Date: Aug. 1, 2002

(54) Multi-ribbed grommet

(76) Inventor: William W. Rowley, Chagrin Falls, OH (US)

Correspondence Address: LOUIS F WAGNER, BUCKINGHAM DOOLITTLE & BURROUGHS, LLP, 50 S MAIN STREET, P O BOX 1500, AKRON, OH, 44309-1500, US

(21) Appl. No.: 09/682,881

(22) Filed: Oct. 29, 2001

(51) Int. Cl. H02G 3/22; F16L 5/00

(52) U.S. Cl. 16/2.1; 248/56; 439/567

(57) ABSTRACT

The invention relates to a grommet having an essentially cylindrical core with an aperture essentially centrally disposed therein and a plurality of radially expanding flexible ribs emanating from the core, the ribs capable of radial deformation compression preferentially in one axial direction in contrast to an opposing axial direction. Alternatively, the radially expanding ribs are envisioned to mimic the geometry of a plurality of Christmas tree shaped or serrated ribs of increasing radial diameter emanating from the core. The grommet can be formed by overmolding of a flexible thermoplastic or a crosslinked polymer (thermoset) onto a plastic tube although the invention is not limited to such and separate insertable grommets onto essentially similarly dimensioned plastic tubes are also within the scope of this invention.

### BACKGROUND OF INVENTION

The invention described herein pertains generally to flexible grommet for insertion into apertures disposed within thin walls.

Appliance construction is rapidly migrating toward the use of thin panel construction. Within cavities between the wall panels and the inner cavities of the appliance, foam is typically found for insulation and some structural supplementing support. The foam is initially deposited into these cavities as a liquid and becomes a solid as it cures and expands providing additional rigidity to the cabinet as well as insulating properties. In this process, it is obvious that any opening in any cabinet wall (typically for water tube inlets and outlets) poses a problem in that expanding foam will quickly migrate out from the hole and additionally create secondary problems in that the foam will not expand into all regions of the cavity, leading to non-uniform heat loss within the appliance.

Prior Art solutions have involved manual taping of the openings into which the water inlet and outlet tubes are positioned. However, this is a problem in that there is a manufacturing cost associated with both the labor and raw materials necessary to effect the closure of the openings as well as the removal of the same after the foaming is complete. Additional Prior Art solutions have involved the use of typical grommets. However, with the shift in the appliance industry to thin wall construction (0.010″ to 0.020″), the physical pressure required to insert grommets is unacceptably high and results in unsightly wall deformation which is rejected by the consumer as damaged merchandise.

However, one solution to this problem is the design of an alternative configuration of the grommet which involves a plurality of radially expanding Christmas-tree shaped multi-ribbed conical grommet, having a flexibility such that the ribs will deform upon insertion into an opening in a thin wall of an appliance without significantly deforming the appliance wall, yet have sufficient memory so that subsequent to penetration through the wall opening, the deformed ribs will reposition themselves to essentially their original configuration, thereby significantly impeding reversing axial movement and sealing the hole. The need for manual taping of the hole is eliminated. Upon foaming with subsequent curing and setting, the tubes cannot move and become an integral part of the foamed panel.

### SUMMARY OF INVENTION

Thus, according to a first aspect of the invention, there is provided a novel design for a grommet, particularly adapted for insertion into thin walled appliances.

It is an object of this invention to provide a grommet which upon insertion into an apertured opening will be biased to have less force required to insert the grommet through forward axial movement than required to remove the grommet through reversed axial movement.

It is another object of this invention to provide a grommet which permits non-coaxial insertion of the grommet into the aperture, yet seal the hole.

These and other objects of this invention will be evident when viewed in light of the drawings, detailed description, and appended claims.

### BRIEF DESCRIPTION OF DRAWINGS

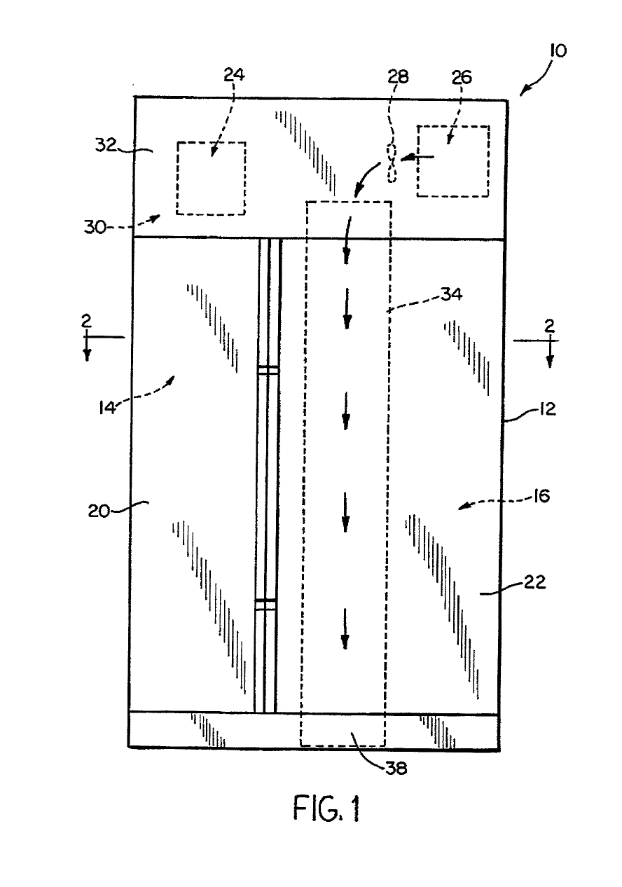

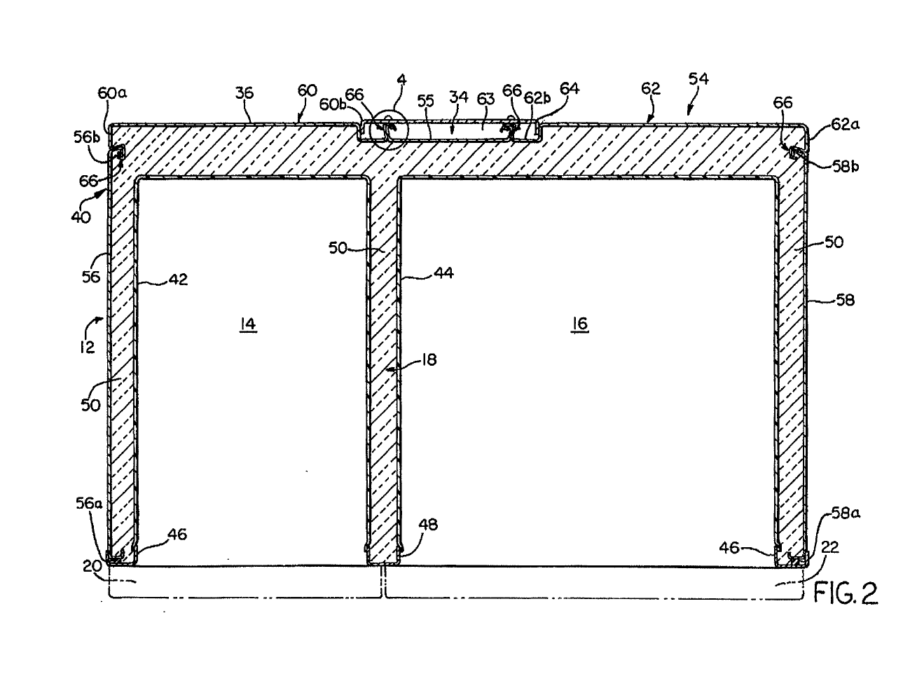

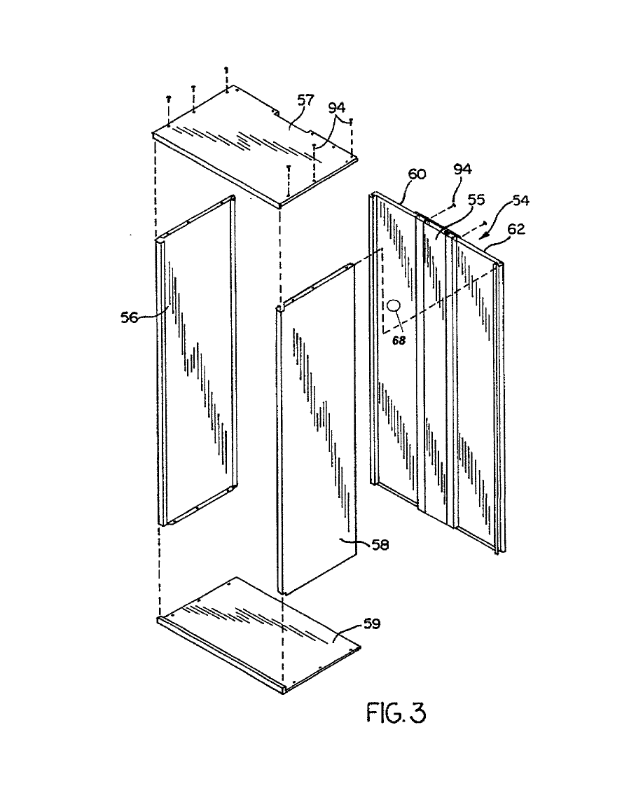

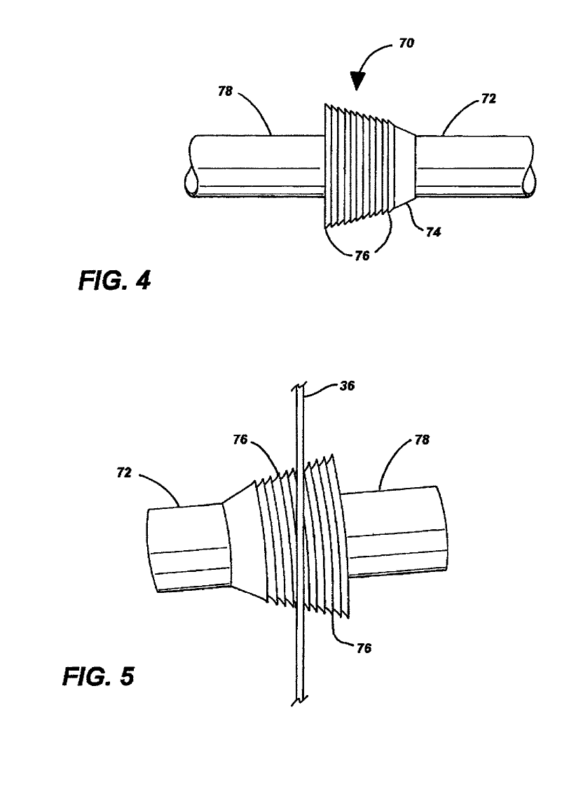

The invention may take physical form in certain parts and arrangements of parts, a preferred embodiment of which will be described in detail in the specification and illustrated in the accompanying drawings which form a part hereof, and wherein: FIG. 7 is a front elevational view of a refrigerator having an outer and inner shell construction; FIG. 2 is a sectional view taken along lines 2-2 of FIG. 1; FIG. 3 is an exploded, perspective view of the outer shell of the refrigerator of FIG. 1; FIG. 4 is an enlarged side plan view of a radially-expanding, multi-ribbed, conical grommet of the invention onto an external periphery of a tube; and FIG. 5 is an enlarged side plan view of the grommet of FIG. 4 shown entering in non-linear axial alignment into a thin wall of an appliance.

### DETAILED DESCRIPTION

Referring now to the drawings wherein the showings are for purposes of illustrating the preferred embodiment of the invention only and not for purposes of limiting the same, the Figures show Referring to FIGS. 1-2, a refrigeration apparatus such as a refrigerator 10 includes a cabinet 12 which defines a below freezing, or freezer compartment 14 and a fresh food compartment 16 separated by a vertical divider wall 18 as illustrated in FIG. 2. A freezer door 20 and a fresh food door 22 are provided for selective access to the freezer and fresh food compartments 14 and 16, respectively.

The freezer and fresh food compartments 14 and 16 are cooled by circulating air therethrough which has been refrigerated as a result of being passed in heat exchange relationship with a conventional evaporator (not shown). In addition to the evaporator, the refrigeration system includes such components as a compressor 24, a condenser 26 and a condenser fan 28 as will be obvious to those skilled in the art. The compressor 24, the condenser 26 and the condenser fan 28 are all disposed within an upper machine compartment 30 of the refrigerator/freezer 70, although it is recognized that various alternate locations for the same are possible. A louvered front panel 32 overlying the machine compartment 30 provides an inlet for ambient air which will be drawn across the condenser 26 by the condenser fan 28. Heated air drawn off the condenser 26 by the condenser fan 28 is partially discharged down an inwardly extending air passageway, or a rear air duct 34 which extends down a back wall 36 of the cabinet 72. The heated air is passed over a defrost water pan (not shown) and is subsequently discharged out through a bottom opening 38.

Referring to FIG. 2, the cabinet 12 includes an outer wrapper or shell 40, a freezer liner 42 and a fresh food liner 44. Outer wall breaker strips 46 extend between the front edges of the liners 42, 44 and the outer shell 40. An additional outer wall breaker strip 48 extends between the freezer liner 42 and the fresh food liner 44. A body of insulation 50 is disposed between the liners 42, 44 and the outer shell 40. The insulation is preferably foam insulation that is blown into the cavity defined between the liners 42, 44 and the shell 40 and subsequently hardens to provide insulation and rigidity to the cabinet 12.

In FIGS. 2-3, it can be seen that the outer wrapper 40 includes a back panel assembly 54, a left side panel 56, a right side panel 58, a top panel 57 and a bottom panel 59. The back panel assembly 54 forms the back wall 36 and comprises a right back panel 62, a left back panel 60 and a rear center panel 55. Panels 56, 55, 58, 57, 59, 60 and 62 are typically manufactured of relatively thin sheet metal and all of them are substantially planar such that they may be easily stacked during work-in-process storage. Each of these panels is typically made from 0.017 inch gauge sheet metal.

The side panels 56, 58 are formed having a front edge 56a, 58a and a rear edge 56b, 58b. The front edges 56a, 58a interconnect with the breaker strips 46. Each of the back panels 60, 62 are formed having a first edge portion 60a, 62a and a second edge portion 60b, 62b. The rear center panel 55 is disposed between the second edge portions 60b, 62b. The center panel 55 and the second edge portion 60b, 62b form a rearwardly opening recess 63. A sheet metal cover 64 is secured to overlie the recess 63 thereby defining the duct 34.

A plurality of linear joints 66 are provided for joining the separate panels 55, 56, 58, 60, 62 of the outer wrapper 40. In particular, each joint 66 is provided between the rear edges 56b, 58b and the first edge portion 60a, 62a and between the second edge portions 60b, 62b and the side edges of the rear center panel 55. Each joint 66 is substantially identical.

It can be seen, therefore, that the outer shell 40 includes a plurality of joints 66 and a rear air duct 34 such that the cabinet 12 is provided with great structural rigidity. The joints 66 provide internal columns of considerable strength to support the refrigeration components disposed in the upper compartment 30. The cross sectional shape of the joints increase the cabinets resistance to bending and twisting.

As described above, outer shell 40 offers a significant benefit over prior art outer shells in that it may be assembled easily without need for any welding or riveting. The panels of the shell are also better interlocked because of the opposed bearing surfaces, which prevent the separation of the panels in response to a lateral force. During the manufacturing process, the outer shell 40 is formed by first assembling the back panel assembly 54. Accordingly, the first the left back panel 60 is connected to the center panel 55 and then the right back panel 62 is connected to the center panel 55. They are assembled such that the inner surface 92 of the back panel assembly 54 faces upwardly.

Subsequently, the side panels 56, 58 are engaged with the channels 68 provided along the first edge portions 60a, 62a and rolled up to a locked position. To complete the shell 40, the top panel 57 and a bottom panel 59 are then attached to the top and bottom edges, respectively, of the side panels 56, 58 the rear panels 60, 62 and the center panel 55 via threaded fasteners 94 or rivets as illustrated in FIG. 3.

It is now common practice to provide an automatic ice maker (not shown) within a freezer compartment 14 optionally coupled with a chilled water dispenser (not shown) of a refrigerator 10 and to further provide a system for dispensing the ice or chilled water into a recessed receiving area formed in a front panel of the refrigerator. In essence, these systems provide for the automatic filling of ice cube trays which are emptied into a collecting bin following a freezing period. From the collecting bin, the ice can be delivered to the receiving area by the selective activation of a delivery system carried by the collecting bin. Most often, such an ice dispensing system will incorporate a mechanism whereby the ice can be selectively crushed prior to reaching the receiving area.

In the industry, there has been proposed various different systems to accomplish this ice dispensing function. In general, the systems differ in the particular manner in which the cubed and crushed ice are delivered to the receiving area and the way in which the ice is actually crushed. With respect to the manner in which the cubed and crushed ice are delivered, it is known in the art to incorporate two doors in an ice dispensing system with one of the doors functioning to direct cubed ice to the crushing area and the other door being used to deliver the cubed or crushed ice to the receiving area. Therefore, depending upon the position of a user-controlled selector unit, either one or both of the doors will be open for the delivery of ice. In another known arrangement, an ice delivery system is mounted for rotation in opposite directions for dispensing the cubed and crushed ice respectively.

In order to implement either the ice-making functionality or the optional chilled water dispensing capability, it is critical that a source of liquid water (often purified by a purification means) be directed from a water line present within the facility within which the refrigerator is housed. This requires the stamping of at least one, and sometimes more than one hole 68 in rear panel 60 of refrigerator 10. In light of the fact that insulation 50 is blown into the cavity defined between the liners 42, 44 and the shell 40 in liquid form, which becomes a solid as it cures and expands and provides additional rigidity to cabinet 12 as well as insulating properties, any opening in any cabinet wall poses a problem in that expanding foam will quickly migrate out from the hole and additionally create problems in having the foam expand into all regions of the cavity.

With the shift in the appliance industry to thin panel wall construction (0.010″ to 0.020″), the physical pressure required to insert grommets is unacceptably high and results in unsightly wall deformation which is rejected by the consumer as damaged merchandise. One solution to this problem is the design of an alternative configuration of the grommet which involves a plurality of radially expanding Christmas-tree shaped multi-ribbed conical grommet a shown in FIG. 4, having a flexibility such that the ribs will deform upon insertion into an opening in a thin wall of an appliance without significantly deforming the appliance wall, yet have sufficient memory so that subsequent to penetration through the wall opening, the deformed ribs will reposition themselves to essentially their original configuration, thereby significantly restricting reversing axial movement and additionally sealing the hole. The need for manual taping of the hole is eliminated. Upon foaming with subsequent curing and setting, the tubes cannot move and become an integral part of the foamed panel.

In general, and depending on the thickness of a panel wall, in a preferred embodiment, the flexible ribs will be made from a polymer having a durometer between approximately 50 Shore A and 85 Shore A inclusive. The flexible polymer is generally a flexible thermoplastic or a crosslinked material, e.g., crosslinked polyethylene. As best illustrated in FIG. 5, the value in the Christmas-tree configuration, lies in its ability to seal an aperture within a panel wall 36 even if the grommet is not inserted linearly and coaxially with a center of the aperture. This is not possible with other grommet configurations.

In manufacture in a preferred embodiment, grommet 70 is overmolded onto a plastic tube in a suitable configured die so as to produce the plurality of flexible ribs 76 so that the tube has a forward portion 72, optionally with a collar 74 and a rear portion 78. The grommet has an essentially cylindrical core having an aperture essentially centrally disposed therein and a plurality of radially expanding flexible ribs from the core, the ribs capable of radial deformation compression preferentially in one axial direction in contrast to an opposing axial direction. In a preferred embodiment, the preferential radial deformation compression occurs when the axial direction is directed toward a front of the grommet and coaxial with inward insertion into a panel of an appliance. Alternatively, the radially expanding ribs are envisioned to mimic the geometry of a plurality of Christmas tree shaped or serrated ribs of increasing radial diameter emanating from the core. The grommet is typically formed by overmolding of a flexible thermoplastic or a crosslinked polymer (thermoset) onto a plastic tube although the invention is not limited to such and separate insertable grommets onto essentially similarly dimensioned plastic tubes are also envisioned to be within the scope of this invention.

The best mode for carrying out the invention has been described for the purposes of illustrating the best mode known to the applicant at the time. The examples are illustrative only and not meant to limit the invention, as measured by the scope and spirit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

1. A grommet which comprises:
(a) An essentially cylindrical core having an aperture essentially centrally disposed therein; and
(b) a plurality of radially expanding ribs from said core, said ribs capable of radial deformation compression preferentially in one axial direction.

2. The grommet of claim 1 wherein the grommet has a durometer between approximately 50 Shore A and 85 Shore A inclusive.

3. A grommet which comprises:
(a) An essentially cylindrical core having an aperture essentially centrally disposed therein; and
(b) a plurality of Christmas tree shaped ribs of increasing radial diameter emanating from said core.

4. The grommet of claim 3 wherein the grommet has a durometer between approximately 50 Shore A and 85 Shore A inclusive.

5. A grommet which comprises:
(a) An essentially cylindrical core having an aperture essentially centrally disposed therein; and
(b) a plurality of serrated ribs of increasing radial diameter emanating from said core.

6.The grommet of claim 5 wherein the grommet has a durometer between approximately 50 Shore A and 85 Shore A inclusive.

7. A grommet which comprises:
(a) an essentially cylindrical core having a front and a back and an aperture essentially centrally disposed therein;
(b) a plurality of ribs of increasing diameter from front to back;
(c) a tip of each rib capable of radial deformation compression preferentially in response to forward axial movement.

8. The grommet of claim 7 wherein the grommet has a durometer between approximately 50 Shore A and 85 Shore A inclusive.

9. A grommet which comprises:
(a) An essentially cylindrical core having an aperture essentially disposd therein; and
(b) A plurality of forward facing ribs capable of radial deformation compression preferentially in response to forward axial movement.

10. The grommet of claim 9 wherein the grommet has a durometer between approximately 50 Shore A and 85 Shore A inclusive.

11. In combination, a tube and grommet which comprises:
(a) an essentially cylindrical hollow plastic tube; and
(b) a grommet in contact with said tube, said grommet comprising:
(i) a cylindrical core having an aperture essentially centrally disposed therein; and
(ii) a plurality of radially expanding ribs from said core, said ribs capable of radial deformation compression preferentially in one axial direction.

12. The grommet of claim 11 wherein the grommet has a durometer between approximately 50 Shore A and 85 Shore A inclusive.

13. In combination, a tube and grommet which comprises:
(a) an essentially cylindrical plastic tube; and
(b) a grommet in contact with said tube, said grommet comprising:
(i) a cylindrical core having an aperture essentially centrally disposed therein; and
(ii) a plurality of Christmas tree shaped ribs of increasing radial diameter emanating from said core.

14. The grommet of claim 13 wherein the grommet has a durometer between approximately 50 Shore A and 85 Shore A inclusive.

15. In combination, a tube and grommet which comprises:
(a) an essentially cylindrical hollow plastic tube; and
(b) a grommet in contact with said tube, said grommet comprising:
(i) a cylindrical core having an aperture essentially centrally disposed therein; and
(ii) a plurality of serrated ribs of increasing radial diameter emanating from said core.

16. The grommet of claim 15 wherein the grommet has a durometer between approximately 50 Shore A and 85 Shore A inclusive.

17. In combination, a tube and grommet which comprises:
(a) an essentially cylindrical hollow plastic tube; and
(b) a grommet which comprises:
(i) an essentially cylindrical core having a front and a back and an aperture essentially centrally disposed therein;
(ii) a plurality of ribs of increasing diameter from front to back;
(iii) a tip of each rib capable of radial deformation compression preferentially in response to forward axial movement.

18.The grommet of claim 17 wherein the grommet has a durometer between approximately 50 Shore A and 85 Shore A inclusive.
